(19) United States
(12) Patent Application Publication
(10) Pub. No.: US 2005/0189726 A1
(43) Pub. Date: Sep. 1, 2005

(54) Door gasket structure for refrigerator

(76) Inventor: Jin-Gyun Shin, Seo-Ku (KR)

Correspondence Address: CANTOR COLBURN, LLP, 55 GRIFFIN ROAD SOUTH, BLOOMFIELD, CT, 06002, US

(21) Appl. No.: 10/903,547

(22) Filed: Jul. 30, 2004

(30) Foreign Application Priority Data
Feb. 26, 2004 (KR) 10-2004-0013037

(51) Int. Cl. F16J 15/50

(52) U.S. Cl. 277/628

(57) ABSTRACT

Disclosed herein is a door gasket structure for a refrigerator. The door gasket structure comprises a recessed groove member embedded in a thermal insulating material in a correspondingly-recessed inner surface region of a refrigerator door, and having an insertion groove, a coupling member in close contact with the groove member, the coupling member having Wan anchor integrally formed at one surface thereof so as to be inserted in the insertion groove by interference fit, a pair of gaskets integrally formed at the other surface of the coupling member, the pair of upper and lower gaskets having vertically-symmetrical U-shaped forms so as to define an air layer therebetween, and a magnet receptacle integrally formed at ends of the pair of gaskets, and containing a magnet.

### BACKGROUND OF THE INVENTION

1. Field of the Invention

The present invention relates to a door gasket structure for a refrigerator, and more particularly to a door gasket structure for a refrigerator which is capable of simplifying assembling, installation and exchange thereof.

2. Description of the Related Art

In general, door gaskets for refrigerators are provided at an inner surface of a refrigerator door, which is hingedly coupled to the front side of a refrigerator body, in order to maintain air-tighteness between the door and the body.

Since such door gaskets for refrigerators usually have a very complex structure, and must be fixedly fastened to an inner panel of a refrigerator door using bolts, etc., they exhibit inconvenience and trouble relating to their assembling, installation and exchange.

Due to structural complexity thereof, furthermore, conventional door gaskets inevitably induce a temperature difference between the inside and outside of a refrigerator body, resulting in a dew condensation problem on a door gasket surface. However, no conventional door gaskets can effectively solve such a dew condensation problem.

Further, inconvenience and trouble in assembling and installation of door gaskets cause a huge labor cost burden as well as a waste of time.

In addition to the above problems, since the conventional door gaskets must be fastened to the inner surface of a refrigerator door by means of separate fastener means, such as bolts, there exist a risk of damaging the inner surface of the door by the fastener means during exchange of the door gaskets.

### SUMMARY OF THE INVENTION

Therefore, the present invention has been made in view of the above problems, and it is an object of the present invention to provide a door gasket structure for a refrigerator which is capable of simplifying assembling, installation and exchange of a door gasket.

It is another object of the present invention to provide a door gasket structure for a refrigerator which is capable of not only restricting dew condensation near a door gasket, but also securing effective removal of dew which is generated.

It is yet another object of the present invention to provide a door gasket structure for a refrigerator which is capable of improving heat insulation efficiency of a refrigerator body by virtue of an increased thickness of a thermal insulating material inside a refrigerator door.

In accordance with the present invention, the above and other objects can be accomplished by the provision of a door gasket structure for a refrigerator comprising: a recessed groove member embedded in a thermal insulating material in a correspondingly-recessed inner surface region of a refrigerator door, and having an insertion groove; a coupling member in close contact with the groove member, the coupling member having an anchor integrally formed at one surface thereof so as to be inserted in the insertion groove by interference fit; a pair of gaskets integrally formed at the other surface of the coupling member, the pair of upper and lower gaskets having vertically-symmetrical U-shaped forms so as to define an air layer therebetween; and a magnet receptacle integrally formed at ends of the pair of gaskets, and containing a magnet.

Preferably, the door gasket structure may further comprise a U-shaped auxiliary gasket integrally formed between a lower position of an outer surface of the coupling member and a lower surface of the magnet receptacle, in order to form an air layer below the gaskets.

Preferably, the groove member may include: an upper contact plate provided at an upper end thereof so as to come into close contact with an inner surface of the door; a lower contact plate provided at a lower end thereof so as to come into close contact with the inner surface of the door; and at least one rib protruding from the lower contact plate into the door at a right angle to the lower contact plate.

Preferably, the groove member may further include a horizontal plate protruding inwardly from a lower end of the lower contact plate for allowing the thermal insulating material inside the door to be extended toward a refrigerator body in a stepped form so as to have an increased thickness.

Preferably, the groove member may further include a fitting portion bent downwardly from a distal end portion of the horizontal plate at a right angle thereto so as to allow an inner panel of the door to be fitted therein.

Preferably, the fitting portion may include: a contact branch extending downward from a distal end of the horizontal plate so that it comes into close contact with an outer surface of the inner panel of the door; and an elastic support branch corresponding to the contact branch, and extending downward from a position near the distal end of the horizontal plate so that it is inclined toward an inner surface of the inner panel.

Preferably, the fitting portion may further include a barb formed at a lower end position of the elastic support branch so as to come into contact with the inner panel.

Preferably, the insertion groove may be formed along upper and lower ends thereof with upper and lower holding flanges, which protrude downwardly and upwardly toward each other, for preventing separation of the anchor of the coupling member.

In order to remove dew which is generated at the groove member, preferably, the door gasket structure may further comprise a heating wire embedded in the thermal insulating material of the door and against an upper surface of the groove member.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a refrigerator of the present invention;

FIG. 2 is a side view of the refrigerator shown in FIG. 1;

FIG. 3 is an enlarged sectional view of the circle portion (A) shown in FIG. 2;

FIG. 4 is an enlarged sectional view of the circle portion (B) shown in FIG. 3; and

FIG. 5 is a sectional exploded perspective view illustrating a door gasket structure for a refrigerator in accordance with the present invention.

### DESCRIPTION OF THE PREFERRED EMBODIMENTS

A preferred embodiment related to a door gasket structure for a refrigerator in accordance with the present invention will be explained with reference to the accompanying drawings.

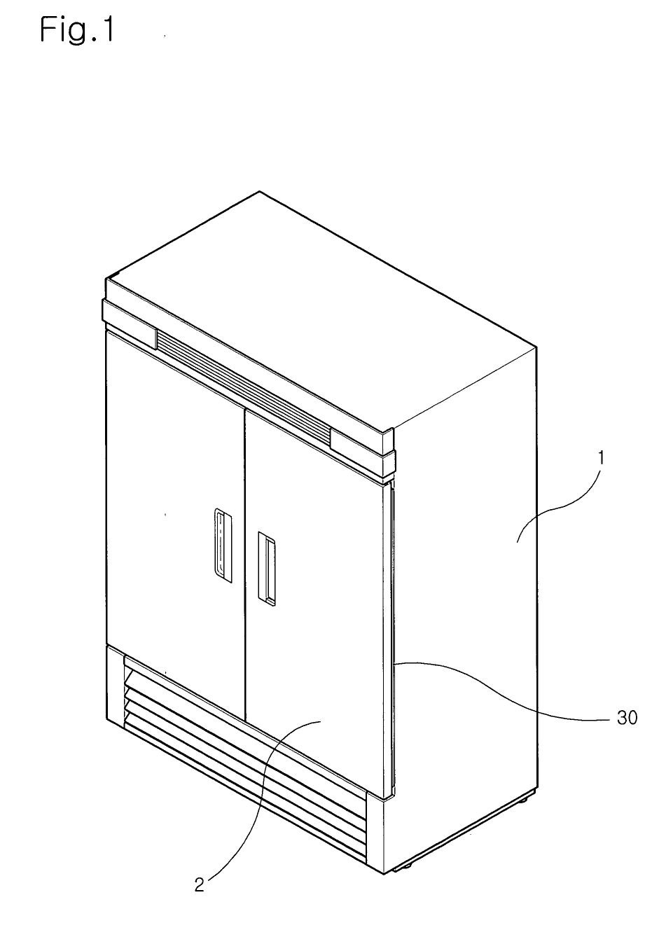

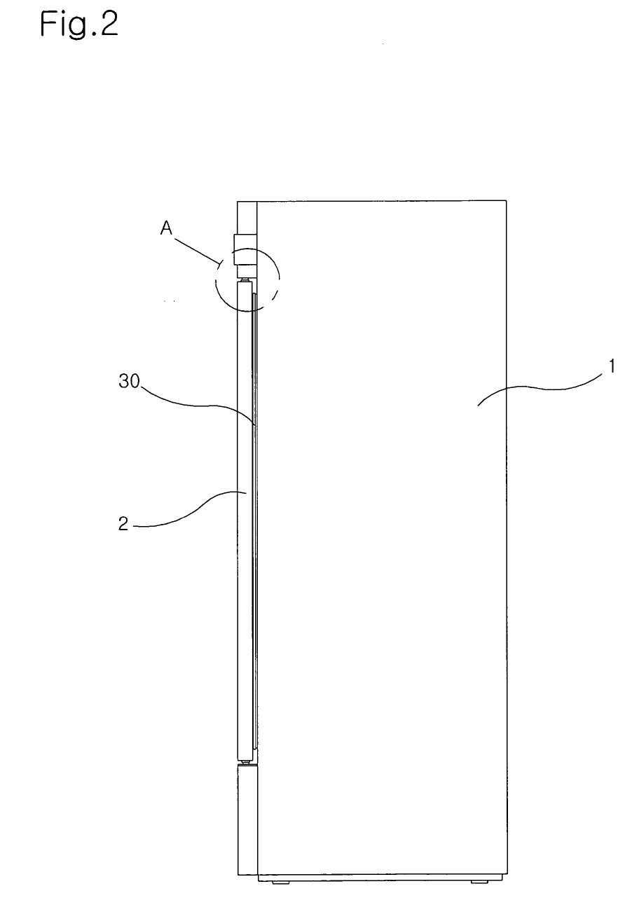

FIG. 1 is a perspective view illustrating a refrigerator of the present invention, and FIG. 2 is a side view of the refrigerator.

As shown in FIGS. 1 and 2, a refrigerator comprises: a body 1 for storing fresh or chilled food; a pair of doors 2 hingedly coupled to a front side of the body 1; and gaskets 30 provided at interconnecting regions between the respective doors 2 and the body 1.

The gaskets 30 are attached to the doors 2 for the purpose of maintaining air-tightness between the doors 2 and the body 1 in a state wherein the door 2 is in close contact with a front surface of the body 1 so as to close it, and further for the purpose of achieving heat insulation between the inside and outside of the body 1.

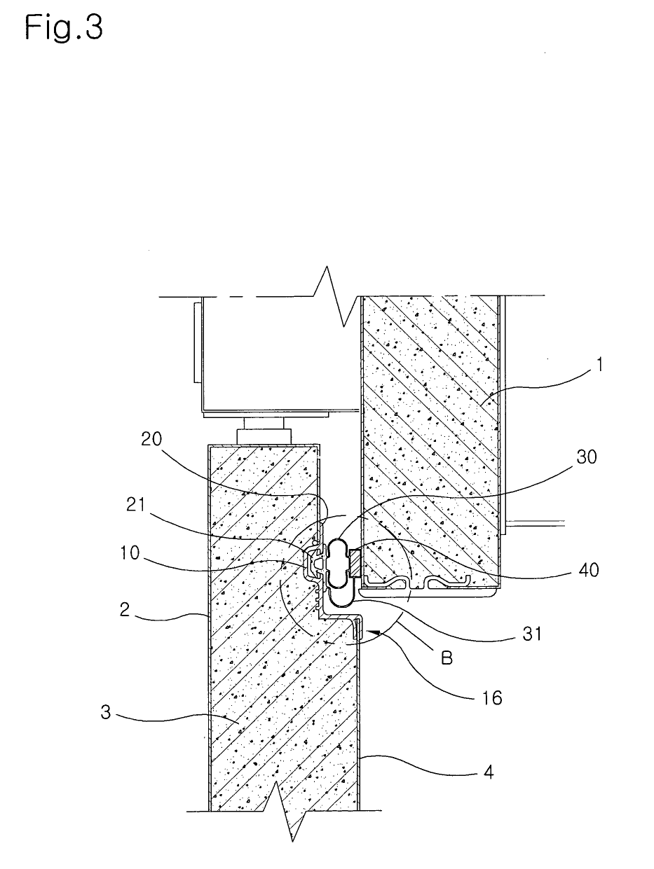

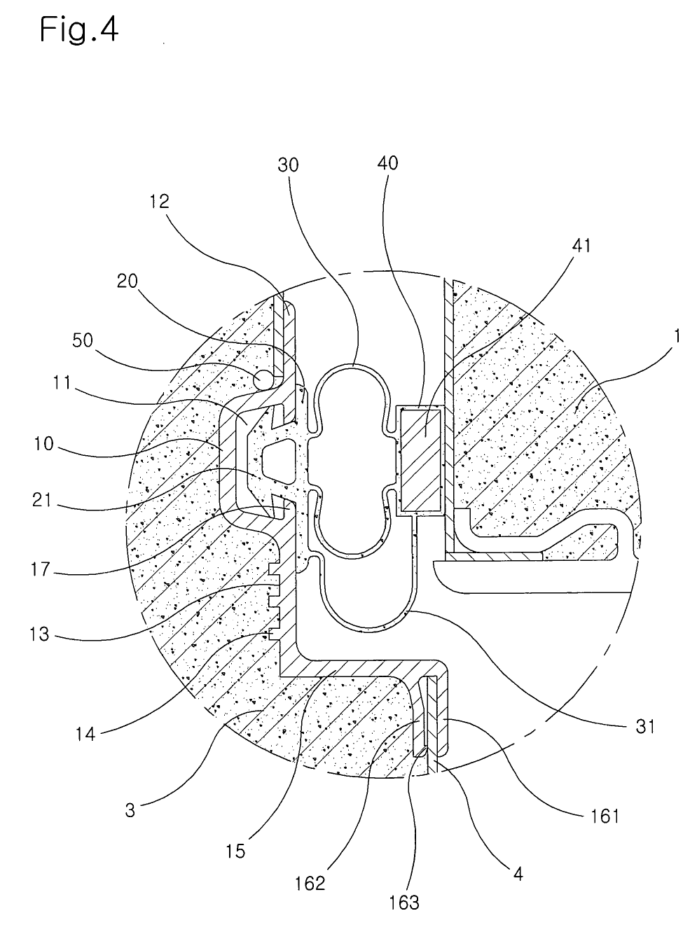

FIG. 3 is an enlarged sectional view of the circle portion (A) shown in FIG. 2, and FIG. 4 is an enlarged sectional view of the circle portion (B) shown in FIG. 3.

As shown in FIGS. 3 and 4, a door gasket structure for a refrigerator in accordance with the present invention comprises: a recessed groove member 10 mounted in a correspondingly-recessed inner surface region of either door 2; a coupling member 20 configured to be coupled in the groove member 10 by interference fit; the gaskets 30 integrally formed at an outer side of the coupling member 20; and a magnet receptacle 40 integrally formed at an outer side of the gaskets 30.

The groove member 10, which is fitted in the correspondingly-recessed inner surface region of the door 2, has an insertion groove 11, and at upper and lower ends of the insertion groove 11 are provided upper and lower contact plates 12 and 13, respectively. The upper and lower contact plates 12 and 13 come into close contact with an inner panel 4 of the door 2. Extending from a lower end of the lower contact plate 13, at right angles thereto, is a horizontal plate 15 protruding inwardly toward the refrigerator body 1. A distal end portion of the horizontal plate 15 is bent perpendicularly and is divided into two branches so as to form a fitting portion 16. Between the two branches of the fitting portion 16 the inner panel 4 is fitted. The insertion groove 11 is further provided along the upper and lower ends thereof with upper and lower holding flanges 17, which protrude downwardly and upwardly toward each other.

In the groove member 10, as it is fixedly embedded in the recessed inner surface portion of the door 2, and an anchor 21 of the coupling member 20 is fitted therein, it serves to allow the gaskets 30 integrally formed with the coupling member 20 to be coupled to the door 2 in an easily detachable manner.

The upper and lower contact plates 12 and 13, forming upper and lower portions of the groove member 10, serve to secure close contact between the groove member 10 and the inner surface of the door 2. Protruding from the lower contact plate 13 into the door 2, at right angles thereto, are a plurality of ribs 14, which serve to reinforce the lower contact plate 13.

In the horizontal plate 15, since it protrudes inwardly from the lower end of the lower contact plate 13 toward the refrigerator body 1, it enables a thermal insulating material 3 inside the door 2 to be extended toward the body 1. Thereby, the thermal insulating material 3 has an increased thickness, and exhibits an improved heat insulation efficiency between the door 2 and the body 1.

The thermal insulating material 3, having such an increased thickness obtainable by the horizontal plate 15, is positioned below the gaskets 30, and serves to partially intercept cold air generated from the interior of the body 1, thereby being capable of restricting dew condensation, which is usually generated at the gaskets 30.

In the fitting portion 16, as it is downwardly bent from the distal end portion of the horizontal plate 15 at right angles thereto and is fitted on the upper end of the inner panel 4 of the door 2, it enables the horizontal plate 15 to be seated on the thickness increased stepped region of the thermal insulating material 3 inside the door 2.

The fitting portion 16 has a contact branch 161 extending downward from a distal end of the horizontal plate 15 so that it comes into close contact with an outer surface of the inner panel 4 of the door 2; an elastic support branch 162 corresponding to the contact branch 161, and extending downward from a position near the distal end of the horizontal plate 15 so that it is inclined toward an inner surface of the inner panel 4; and a barb 163 formed at a lower end position of the elastic support branch 162 so as to come into contact with the inner panel 4.

As the contact branch 161 comes into close contact with the outer surface of the inner panel 4 and the elastic support branch 162 elastically supports the inner surface of the inner panel 4, consequently, the horizontal plate 15 is firmly fixed to the inner panel 4. Further, the barb 163 formed at the elastic support branch 162 serves to increase a support force of the elastic support branch 162.

The holding flanges 17, which are formed at both the upper and lower ends of the insertion groove 11 so as to protrude downwardly and upwardly toward each other, serve to prevent the anchor 21, which was fitted in the insertion groove 11, from being accidentally removed from the insertion groove 11.

The coupling member 20 comes into close contact with an outer surface of the groove member 10 as the anchor 21 thereof is interference fitted in the insertion groove 11 of the groove member 10. In such an interference fitted state, of course, the anchor 21 is removable from the insertion groove 11, and consequently, the coupling member 20 is easily detachable from the groove member 10.

The gaskets 30 are a pair of upper and lower gaskets integrally formed at the outer side of the coupling member 20. Both the inverted U-shaped upper gasket 30 and the U-shaped lower gasket 30 define an air layer therebetween, which serves as a thermal insulation layer between the door 2 and the body 1.

Positioned below the lower gasket 30 is a U-shaped auxiliary gasket 31. One end of the auxiliary gasket 31 is attached to a lower position of the outer surface of the coupling member 20, and the other end thereof is attached to a lower surface of the magnet receptacle 40, and serves to form an additional air layer below the lower gasket 30. In this way, between the door 2 and the body 1 are formed double thermal insulation layers.

The magnet receptacle 40, which is integrally formed at outer ends of the pair of gaskets 30, contains a magnet 41 therein. By making use of a magnetic force of the magnet 41, the magnet receptacle 41 can be firmly attached to the front surface of the body 1.

Embedded in the thermal insulating material 3 of the door 2 and against an upper surface of the groove member 10 is a heating wire 50, which serves to prevent dew condensation usually generated at the groove member 10 and the coupling member 20.

With the above described configuration of the door gasket structure, in a state wherein the groove member 10 is embedded in the corresponding recessed region of the inner panel 4 of the door 2, as the upper contact plate 12 is attached to the inner panel 4, and the fitting portion 16 is fitted on the incised upper end of the inner panel 4, the groove member 10 can be easily assembled to the door 2.

After the groove member 10 is assembled in the inner panel 4 as stated above, the thermal insulating material 3 is formed in the interior of the door 2 by foaming. In this way, the groove member 10 can be firmly fixed to the door 2 in a simplified manner.

Since the coupling member 20, the gaskets 30, the auxiliary gasket 31, and the magnet receptacle 40 are made of soft synthetic resin material in a single unit form, overall manufacturing and assembling thereof can be simplified. Further, the anchor 21 of the coupling member 20 is smoothly interference fitted in the insertion groove 11, and the gaskets 30 and the auxiliary gasket 31 come into close contact with the body 1.

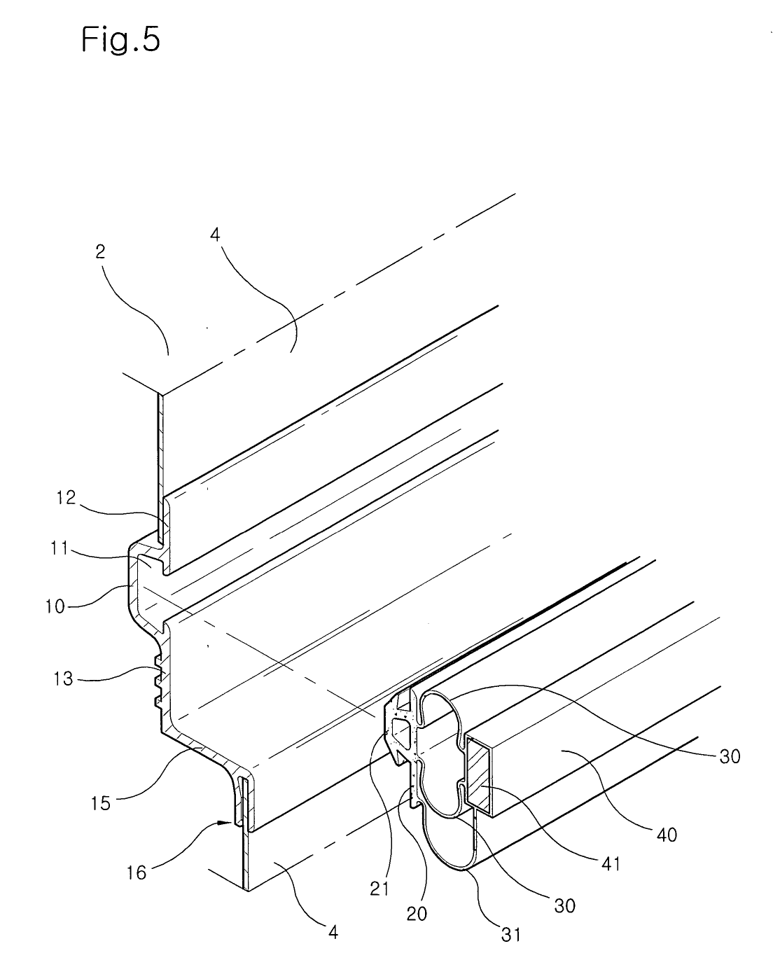

FIG. 5 is a sectional exploded perspective view illustrating the door gasket structure of the present invention.

As shown in FIG. 5, in a state wherein the inner panel 4 of the door 2 is cut into upper and lower sections, and is rearranged to have a stepped form, the upper contact plate 12 of the groove member 10 is attached to the upper section of the inner panel 4, and the fitting portion 16 is fitted on the upper end of the lower section of the lower inner panel 4, so that the groove member 10 is fixedly mounted between these stepped upper and lower sections of the inner panel 4.

In succession, the thermal insulating material 3 is formed in the interior of the door 2 by foaming, so as to achieve firm fixation of the groove member 10.

In this case, by virtue of the horizontal plate 15 protruding from the lower end of the lower contact plate 13 at right angles thereof, the thickness of the thermal insulating material is increased toward the body 1.

After completing the fixation of the groove member 10, the anchor 21 of the coupling member 20 is inserted in the insertion groove 11 of the groove member 10 by interference fit. Here, the coupling member 20 is previously integrated with the gaskets 30, the auxiliary gasket 31, and the magnet receptacle 40 containing the magnet 41.

In this way, according to the present invention, the door gasket structure for a refrigerator can be assembled and installed to the door 2 in a simplified manner. Further, since the anchor 21 is easily detachable from the insertion groove 11, the exchange of the gaskets 30 can be easily achieved.

As apparent from the above description, the present invention provides a door gasket structure for a refrigerator, which is capable of allowing assembling, installation and exchange of door gaskets to be easily and rapidly achieved in a simplified manner even while preventing damage to a refrigerator door during exchange of the gaskets.

Further, according to the present invention, it is possible to restrict dew condensation near the gaskets, as well as to effectively remove dew which is generated.

Furthermore, the present invention allows a thermal insulating material inside the refrigerator door to have an increased thickness, thereby improving heat insulation efficiency of a refrigerator body.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A door gasket structure for a refrigerator comprising:
a recessed groove member embedded in a thermal insulating material in a correspondingly-recessed inner surface region of a refrigerator door, and having an insertion groove;
a coupling member in close contact with the groove member, the coupling member having an anchor integrally formed at one surface thereof so as to be inserted in the insertion groove by interference fit;
a pair of gaskets integrally formed at the other surface of the coupling member, the pair of upper and lower gaskets having vertically-symmetrical U-shaped forms so as to define an air layer therebetween; and
a magnet receptacle integrally formed at ends of the pair of gaskets, and containing a magnet.

2. The structure as set forth in claim 1, further comprising:
a U-shaped auxiliary gasket integrally formed between a lower position of an outer surface of the coupling member and a lower surface of the magnet receptacle, in order to form an air layer below the gaskets.

3. The structure as set forth in claim 1, wherein the groove member includes:
an upper contact plate provided at an upper end thereof so as to come into close contact with an inner surface of the door;
a lower contact plate provided at a lower end thereof so as to come into close contact with the inner surface of the door; and
at least one rib protruding from the lower contact plate into the door at a right angle to the lower contact plate.

4. The structure as set forth in claim 2, wherein the groove member includes:
an upper contact plate provided at an upper end thereof so as to come into close contact with an inner surface of the door;
a lower contact plate provided at a lower end thereof so as to come into close contact with the inner surface of the door; and
at least one rib protruding from the lower contact plate into the door at a right angle to the lower contact plate.

5. The structure as set forth in claim 3, wherein the groove member further includes:
a horizontal plate protruding inwardly from a lower end of the lower contact plate for allowing the thermal insulating material inside the door to be extended toward a refrigerator body in a stepped form so as to have an increased thickness.

6. The structure as set forth in claim 4, wherein the groove member further includes:
a horizontal plate protruding inwardly from a lower end of the lower contact plate for allowing the thermal insulating material inside the door to be extended toward a refrigerator body in a stepped form so as to have an increased thickness.

7. The structure as set forth in claim 5, wherein the groove member further includes:
a fitting portion bent downwardly from a distal end portion of the horizontal plate at a right angle thereto so as to allow an inner panel of the door to be fitted therein.

8. The structure as set forth in claim 6, wherein the groove member further includes:
a fitting portion bent downwardly from a distal end portion of the horizontal plate at a right angle thereto so as to allow an inner panel of the door to be fitted therein.

9. The structure as set forth in claim 7, wherein the fitting portion includes:
a contact branch extending downward from a distal end of the horizontal plate so that it comes into close contact with an outer surface of the inner panel of the door; and
an elastic support branch corresponding to the contact branch, and extending downward from a position near the distal end of the horizontal plate so that it is inclined toward an inner surface of the inner panel.

10. The structure as set forth in claim 8, wherein the fitting portion includes:
a contact branch extending downward from a distal end of the horizontal plate so that it comes into close contact with an outer surface of the inner panel of the door; and
an elastic support branch corresponding to the contact branch, and extending downward from a position near the distal end of the horizontal plate so that it is inclined toward an inner surface of the inner panel.

11. The structure as set forth in claim 9, wherein the fitting portion further includes:
a barb formed at a lower end position of the elastic support branch so as to come into contact with the inner panel.

12. The structure as set forth in claim 10, wherein the fitting portion further includes:
a barb formed at a lower end position of the elastic support branch so as to come into contact with the inner panel.

13. The structure as set forth in claim 1, wherein the insertion groove is formed along upper and lower ends thereof with upper and lower holding flanges, which protrude downwardly and upwardly toward each other, for preventing separation of the anchor of the coupling member.

14. The structure as set forth in claim 3, wherein the insertion groove is formed along upper and lower ends thereof with upper and lower holding flanges, which protrude downwardly and upwardly toward each other, for preventing separation of the anchor of the coupling member.

15. The structure as set forth in claim 12, wherein the insertion groove is formed along upper and lower ends thereof with upper and lower holding flanges, which protrude downwardly and upwardly toward each other, for preventing separation of the anchor of the coupling member.

16. The structure as set forth in claim 1, further comprising:
a heating wire embedded in the thermal insulating material of the door and against an upper surface of the groove member.

17. The structure as set forth in claim 3, further comprising:
a heating wire embedded in the thermal insulating material of the door and against an upper surface of the groove member.

18. The structure as set forth in claim 12, further comprising:
a heating wire embedded in the thermal insulating material of the door and against an upper surface of the groove member.

19. The structure as set forth in claim 15, wherein further comprising:
a heating wire embedded in the thermal insulating material of the door and against an upper surface of the groove member.
